(19) United States
(12) Patent Application Publication
(10) Pub. No.: US 2019/0340332 A1
(43) Pub. Date: Nov. 7, 2019

(54) METHOD, SYSTEM AND NON-TRANSITORY COMPUTER-READABLE RECORDING MEDIUM FOR PROVIDING PREDICTION ABOUT BREEDING

(71) Applicants: Fungi and Plants Corporation, Chungbuk-do (KR); The Regents of the University of California, Oakland, CA (US)

(72) Inventors: Julin Nassir Maloof, Davis, CA (US); John Thompson Davis, Davis, CA (US); Shinje Kim, Chungbuk-do (KR); Seungmo Kim, Chungbuk-do (KR)

(73) Assignees: Fungi and Plants Corporation, Chungbuk-do (KR); The Regents of the University of California, Oakland, CA (US)

(21) Appl. No.: 16/110,170

(22) Filed: Aug. 23, 2018

Related U.S. Application Data
(60) Provisional application No. 62/668,045, filed on May 7, 2018.

(51) Int. Cl. G06F 19/24; G06F 19/18; G06F 17/18

(52) U.S. Cl. CPC G06F 19/24; G06F 17/18; G06F 19/18

(57) ABSTRACT

According to one aspect of the invention, there is provided a method for providing a prediction about breeding, comprising the steps of: acquiring from a user at least one of information on at least one target phenotype to be had by a subject individual and information on limiting conditions related to the subject individual; determining genotypes that satisfy the limiting conditions among genotypes that are correlated with the at least one target phenotype; and providing the user with at least one of estimated information on at least one phenotype acquirable by mating the determined genotypes and estimated information on a probability of the at least one target phenotype being acquired by mating the determined genotypes, on the basis of at least one statistical model.

### CROSS-REFERENCE TO RELATED APPLICATIONS

This application claims priority to U.S. Provisional Application 62/668,045 filed on May 7, 2018 and Korean Patent Application No. 10-2018-0052277 filed on May 8, 2018, the entire contents of which are hereby incorporated by reference.

### FIELD OF THE INVENTION

The present invention relates to a method, system, and non-transitory computer-readable recording medium for providing a prediction about breeding.

### BACKGROUND

The development of genomic technology has made it easier and simpler to find out information on phenotypes or genotypes of traits of plants or animals (e.g., genetic organizations thereof), and various studies are currently carried out on the basis of such information to breed plants and animals with improved traits.

As an example of related conventional techniques, Korean Laid-Open Patent Publication No. 2010-91536 discloses a method for breeding a super-multiparous soybean line, which is acquired by artificially mating a variety of Pugsan-namul soybeans (♀) and a SS2-2 variety derived from Sinpaldal soybeans No. 2 (♂), and characterized in having 127 to 562 pods per individual, 8 to 13 branches per individual, and a unit yield of 603 kg/10a.

However, according to the techniques introduced so far as well as the above-described conventional techniques, there is a problem that accessibility is severely limited due to considerable time and astronomical costs consumed in the course of breeding tests, because one could see if an individual having a desired trait (e.g., oil-rich rapeseed) might be acquired only after experiencing trial and error through numerous matings between various individuals.

In this connection, the inventor(s) present a technique for assisting a user to easily input (or set) a desired target phenotype for a subject individual, and providing the user with information on a prediction about breeding derived on the basis of the target phenotype in a user-friendly manner.

### SUMMARY OF THE INVENTION

One object of the present invention is to solve all the above-described problems in the prior art.

Another object of the invention is to easily find out parent individuals to be mated to acquire a subject individual having a target phenotype.

Yet another object of the invention is to provide parent individuals to be mated to acquire a subject individual having a target phenotype, according to predetermined criteria (or priorities) desired by a user.

Still another object of the invention is to minimize trial and error occurring in the course of breeding a subject individual having a target phenotype.

The representative configurations of the invention to achieve the above objects are described below.

According to one aspect of the invention, there is provided a method for providing a prediction about breeding, comprising the steps of: acquiring from a user at least one of information on at least one target phenotype to be had by a subject individual and information on limiting conditions related to the subject individual; determining genotypes that satisfy the limiting conditions, among genotypes that are correlated with the at least one target phenotype; and providing the user with at least one of estimated information on at least one phenotype acquirable by mating the determined genotypes and estimated information on a probability of the at least one target phenotype being acquired by mating the determined genotypes, on the basis of at least one statistical model.

According to another aspect of the invention, there is provided a system for providing a prediction about breeding, comprising: an information acquisition unit configured to acquire from a user information on at least one target phenotype to be had by a subject individual and limiting conditions related to the subject individual; a genotype determination unit configured to determine genotypes that satisfy the limiting conditions, among genotypes that are correlated with the at least one target phenotype; and a result provision unit configured to provide the user with estimated information on at least one phenotype acquirable by mating the determined genotypes and a probability of the at least one target phenotype being acquired by mating the determined genotypes, on the basis of at least one statistical model.

In addition, there are further provided other methods and systems to implement the invention, as well as non-transitory computer-readable recording media having stored thereon computer programs for executing the methods.

According to the invention, it is possible to easily find out parent individuals to be mated to acquire a subject individual having a target phenotype.

According to the invention, it is possible to provide parent individuals to be mated to acquire a subject individual having a target phenotype, according to predetermined criteria (or priorities) desired by a user.

According to the invention, it is possible to minimize trial and error occurring in the course of breeding a subject individual having a target phenotype.

### BRIEF DESCRIPTION OF THE DRAWINGS

FIG. 1 schematically shows the configuration of an entire system for providing a prediction about breeding according to one embodiment of the invention.

FIG. 2 specifically shows the internal configuration of a service provision system according to one embodiment of the invention.

FIG. 3 illustratively shows how a prediction about breeding is provided according to one embodiment of the invention.

FIG. 4 illustratively shows how a prediction about breeding is provided according to one embodiment of the invention.

FIG. 5 illustratively shows how a prediction about breeding is provided according to one embodiment of the invention.

FIG. 6 illustratively shows how a prediction about breeding is provided according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Herein, a single nucleotide polymorphism (SNP) refers to a genetic change or mutation that shows difference in at least one base sequence (A, T, G, C) in a DNA sequence.

Herein, an individual (or a subject individual) refers to a living organism that is composed of tissues and organs, which are an aggregate of cells, and acts as a minimal unit in survival. Such individuals may include plants, animals, and the like.

Hereinafter, various preferred embodiments of the present invention will be described in detail with reference to the accompanying drawings to enable those skilled in the art to easily implement the invention.

Configuration of the Entire System

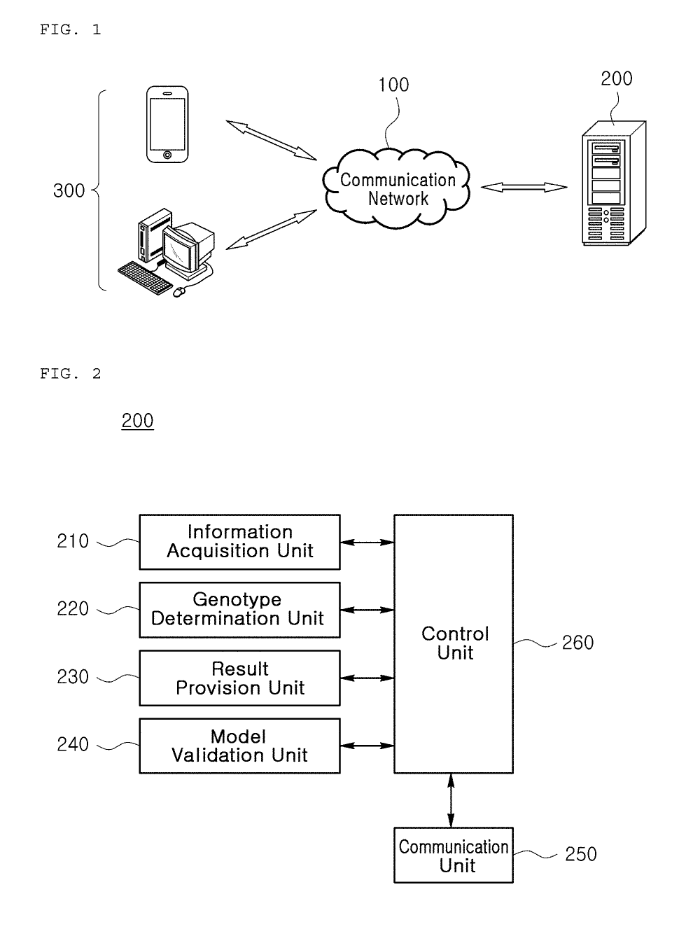

FIG. 1 schematically shows the configuration of an entire system for providing a prediction about breeding according to one embodiment of the invention.

As shown in FIG. 1, the entire system according to one embodiment of the invention may comprise a communication network 100, a service provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, Bluetooth communication (e.g., Bluetooth Low Energy (BLE) communication), infrared communication, and ultrasonic communication.

Next, the service provision system 200 according to one embodiment of the invention may communicate with the device 300 to be described below via the communication network 100, and may function to acquire from a user at least one of information on at least one target phenotype to be had by a subject individual and information on limiting conditions related to the subject individual, to determine genotypes that satisfy the limiting conditions, among genotypes that are correlated with the at least one target phenotype, and to provide the user with at least one of estimated information on at least one phenotype acquirable by mating the determined genotypes and estimated information on a probability of the at least one target phenotype being acquired by mating the determined genotypes, on the basis of at least one statistical model.

The configuration and function of the service provision system 200 according to the invention will be discussed in more detail below. Meanwhile, although the service provision system 200 has been described as above, the above description is illustrative and it will be apparent to those skilled in the art that at least a part of the functions or components required for the service provision system 200 may be implemented or included in the device 300 to be described below or an external system (not shown), as necessary.

Next, the device 300 according to one embodiment of the invention is digital equipment that may function to connect to and then communicate with the service provision system 200 via the communication network 100, and any type of digital equipment having a memory means and a microprocessor for computing capabilities, such as a smart phone and a tablet PC, may be adopted as the device 300 according to the invention.

Meanwhile, according to one embodiment of the invention, the device 300 may include an application to support functions for providing a prediction about breeding according to the invention. The application may be downloaded from the service provision system 200 or an external application distribution server (not shown).

Configuration of the Service Provision System

Hereinafter, the internal configuration of the service provision system 200 crucial for implementing the invention and the functions of the respective components thereof will be discussed.

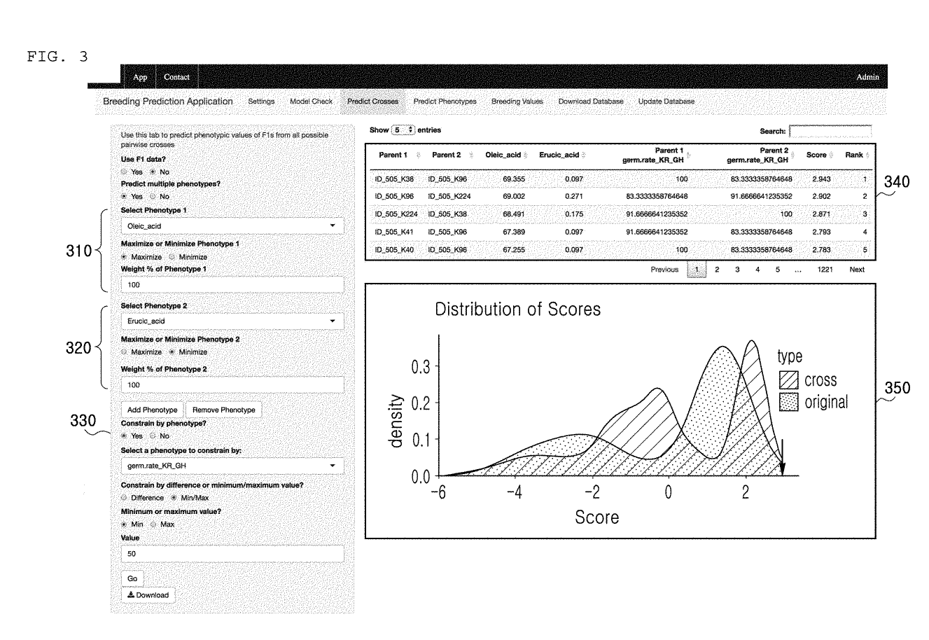

FIG. 2 specifically shows the internal configuration of the service provision system 200 according to one embodiment of the invention.

The service provision system 200 according to one embodiment of the invention may be digital equipment having a memory means and a microprocessor for computing capabilities. The service provision system 200 may be a server system. As shown in FIG. 2, the service provision system 200 may comprise an information acquisition unit 210, a genotype determination unit 220, a result provision unit 230, a model validation unit 240, a communication unit 250, and a control unit 260. According to one embodiment of the invention, at least some of the information acquisition unit 210, the genotype determination unit 220, the result provision unit 230, the model validation unit 240, the communication unit 250, and the control unit 260 may be program modules to communicate with an external system. The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures, and the like for performing specific tasks or executing specific abstract data types as will be described below in accordance with the invention.

First, the information acquisition unit 210 according to one embodiment of the invention may acquire from a user at least one of information on at least one target phenotype to be had by a subject individual and information on limiting conditions related to the subject individual. According to one embodiment of the invention, the limiting conditions related to the subject individual may include, for example, limiting conditions related to growth, germination, and the like of the subject individual (e.g., flowering times, germination rates, etc.) and limiting conditions on characteristics of a kingdom, a phylum (a division in case of a plant), a class, an order, a family, a genus, a species, or the like related to the subject individual.

For example, assuming that the subject individual according to one embodiment of the invention is a bean, the information on the at least one target phenotype may be that the bean is round and green, and the information on the limiting conditions may be that the flowering time is March or that the number of pods per individual is not less than 40.

Next, the genotype determination unit 220 according to one embodiment of the invention may determine genotypes that satisfy the limiting conditions, among genotypes that are correlated with the at least one target phenotype.

For example, the genotype determination unit 220 according to one embodiment of the invention may specify genotypes that affect expression of the at least one target phenotype at or above a predetermined level, among genotypes of the subject individual or of a species related to the subject individual, and may determine genotypes that satisfy the limiting conditions among the specified genotypes.

More specifically, the genotype determination unit 220 according to one embodiment of the invention may determine genotypes having SNPs that affect expression of the at least one target phenotype at or above a predetermined level, among genotypes of the subject individual or of a species related to the subject individual, as the genotypes correlated with the at least one target phenotype. Further, the genotype determination unit 220 according to one embodiment of the invention may specify the genotypes correlated with the at least one target phenotype, with further reference to loci where SNPs that affect the at least one target phenotype at or above a predetermined level are located in the genotypes of the subject individual or the species related thereto.

Next, the result provision unit 230 according to one embodiment of the invention may provide the user with at least one of estimated information on at least one phenotype acquirable by mating the genotypes determined by the genotype determination unit 220, and estimated information on a probability of the at least one target phenotype being acquired by mating the genotypes determined by the genotype determination unit 220, on the basis of at least one statistical model.

For example, the result provision unit 230 according to one embodiment of the invention may generate at least one of estimated information on at least one phenotype acquirable by mating the determined genotypes and estimated information on a probability of the at least one target phenotype being acquired by mating the determined genotypes, on the basis of at least one statistical model among a ridge regression (RR) method, an ordinary least squares (OLS) method, and a Bayesian method, and may provide the estimated information to the user. Meanwhile, the above-described statistical models are illustrative, and various statistical models may be used as long as the objects of the invention may be achieved.

Further, the result provision unit 230 according to one embodiment of the invention may determine at least one recommended mating combination to be provided to the user, with reference to at least one of estimated information on at least one phenotype acquirable by mating the determined genotypes and estimated information on a probability of the at least one target phenotype being acquired by mating the determined genotypes.

For example, the result provision unit 230 according to one embodiment of the invention may determine at least one mating pair of genotypes (or individuals having the genotypes) on the basis of the determined genotypes, and may calculate a probability of acquiring the target phenotype corresponding to the at least one determined mating pair, and determine the mating pair whose probability of acquiring the target phenotype is not less than a predetermined level, among the at least one mating pair, as the recommended mating combination to be provided to the user.

In addition, the result provision unit 230 according to one embodiment of the invention may further provide information on a breeding value of the at least one target phenotype.

For example, the result provision unit 230 according to one embodiment of the invention may calculate an estimated breeding value (EBV) of the subject individual on the basis of at least one of a selection index (SI) method, a least-square method (LM), and a best linear unbiased prediction (BLUP) method, and may provide the value to the user.

Next, the model validation unit 240 according to one embodiment of the invention may provide the user with a result of validating the at least one statistical model for generating the above-described estimated information.

For example, when the user sets the at least one statistical model for generating the above estimated information, the model validation unit 240 according to one embodiment of the invention may perform cross validation on the basis of at least one cross validation method such as a K-fold method, a validation set method, and a holdout method, and may provide the user with a result of performing the cross validation. More specifically, according to one embodiment of the invention, performance of the at least one statistical model and a graph related to the performance may be provided to the user as the result of performing the cross validation.

Next, the communication unit 250 according to one embodiment of the invention may function to enable data transmission/reception from/to the information acquisition unit 210, the genotype determination unit 220, the result provision unit 230, and the model validation unit 240.

Lastly, the control unit 260 according to one embodiment of the invention may function to control data flow among the information acquisition unit 210, the genotype determination unit 220, the result provision unit 230, the model validation unit 240, and the communication unit 250. That is, the control unit 260 according to the invention may control data flow into/out of the service provision system 200 or data flow among the respective components of the service provision system 200, such that the information acquisition unit 210, the genotype determination unit 220, the result provision unit 230, the model validation unit 240, and the communication unit 250 may carry out their particular functions, respectively.

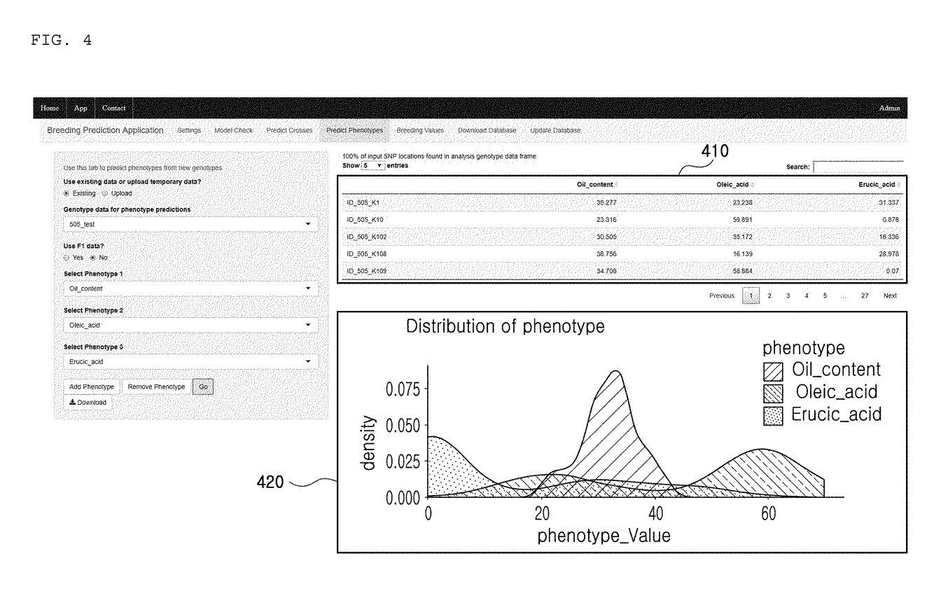

FIGS. 3 to 6 illustratively show how a prediction about breeding is provided according to one embodiment of the invention.

Hereinafter, a number comprising a prefix “ID_” (e.g., ID_1_K1, ID_2_K100, etc.) may refer to an identification number matched for each individual related to a subject individual (e.g., of the same species) in a pre-stored database (not shown).

First, referring to FIG. 3, the service provision system 200 according to one embodiment of the invention may acquire from a user at least one of information on at least one target phenotype 310, 320 to be had by the subject individual and information on limiting conditions 330 related to the subject individual.

For example, according to one embodiment of the invention, the target phenotypes 310, 320 may be traits of having oleic acid and erucic acid, and the limiting conditions 330 may be limiting conditions for germination rates.

Next, the service provision system 200 according to one embodiment of the invention may specify genotypes correlated with the at least one target phenotype, and then determine genotypes that satisfy the limiting conditions 330 among the specified genotypes.

Next, the service provision system 200 according to one embodiment of the invention may provide the user with estimated information on a probability of the at least one target phenotype being acquired by mating the determined genotypes, on the basis of at least one statistical model.

For example, the service provision system 200 according to one embodiment of the invention may calculate a probability of the at least one target phenotype being acquired by mating at least one pair of individuals having the determined genotypes, and then provide the user with a table 340 of the probability of the at least one target phenotype being acquired by mating the pair of individuals, or a graph 350 of a distribution of the probability.

More specifically, the service provision system 200 according to one embodiment of the invention may provide the table 340 in which the pairs of individuals are provided in descending order by the probability of acquiring an individual with phenotypes of having oleic acid and erucic acid (more specifically, phenotypes of having high oleic acid content and low erucic acid content). That is, not only the probability of acquiring an individual having a specific phenotype may be calculated, but also the probability may be calculated even in consideration of an expression level of the specific phenotype (e.g., the phenotype of having oleic acid may be strongly expressed so that the content of oleic acid may be high, while the phenotype of having erucic acid may be weakly expressed so that the content of erucic acid may be low). (In the case of FIG. 3, the phenotype of having oleic acid may be maximized and the phenotype of having erucic acid may be minimized.) For example, when parent individuals ID_505_K38 and ID_505_K96 (i.e., the individuals having the determined genotypes) are mated, the user may be provided with the table 340 to show information indicating that the probability of acquiring an individual having the high oleic acid phenotype and low erucic acid phenotype (e.g., the probability according to the degree of satisfying the conditions for the high oleic acid phenotype and low erucic acid phenotype) is highest (e.g., in this case, a score corresponding to the probability may be calculated to be 2.943 through a predetermined scaling process), and that the individual is expected to have an oleic acid value of 43.613 and an erucic acid value of 13.733. (The oleic acid value and erucic acid value may be calculated through a predetermined scaling process.) Meanwhile, according to one embodiment of the invention, the individuals having the determined genotypes may be of the same or different species as the aforementioned subject individual. That is, the parent individuals to be mated to acquire the subject individual having the target phenotype are not limited to the same species as the subject individual, but may extend even to individuals of different species that may be potentially mated.

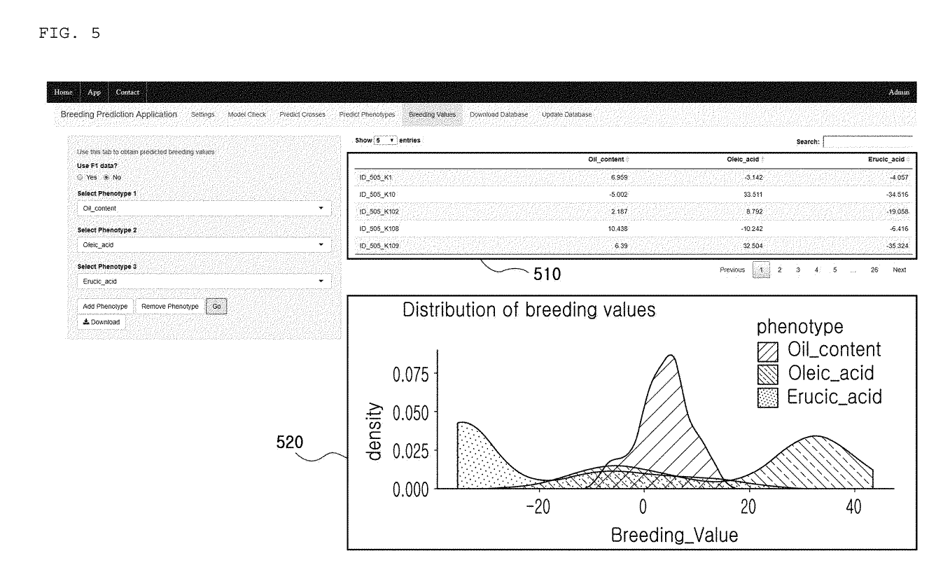

Further, referring to FIG. 4, the service provision system 200 according to one embodiment of the invention may further provide the user with estimated information on at least one phenotype acquirable by mating the determined genotypes, on the basis of the at least one statistical model.

For example, the service provision system 200 according to one embodiment of the invention may calculate at least one phenotype acquirable by mating at least one pair of individuals having the determined genotypes, and then provide the user with a table 410 of the at least one phenotype or a graph 420 of a distribution of the at least one phenotype.

More specifically, the service provision system 200 according to one embodiment of the invention may provide the user with the table 410 to show information indicating that individuals ID_505_K1, ID_505_K10, ID_505_K102, ID_505_K108, and ID_505_K109 have phenotypes of having oleic acid and erucic acid, and that the individuals are expected to have oleic acid values of 23.238, 59.891, 35.172, 16.139, and 58.884, and erucic acid values of 31.337, 0.878, 16.336, 28.978, and 0.07, respectively. (The oleic acid values and erucic acid values may be calculated through a predetermined scaling process.) That is, the user may use such information to select and grow an individual having a desired phenotype from a seedling stage.

Further, the service provision system 200 according to one embodiment of the invention may further provide the user with at least one recommended mating combination, which is determined on the basis of at least one of the estimated information on the at least one phenotype acquirable by mating the determined genotypes, and the estimated information on the probability of the at least one target phenotype being acquired by mating the determined genotypes.

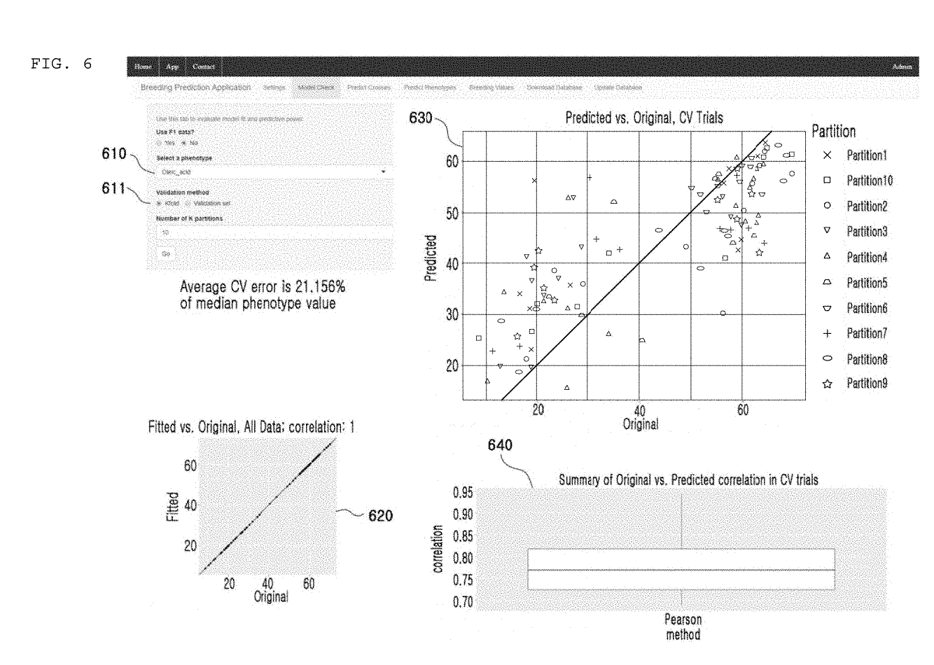

In addition, referring to FIG. 5, the service provision system 200 according to one embodiment of the invention may further provide information on a breeding value of the at least one target phenotype.

For example, the service provision system 200 according to one embodiment of the invention may provide the user with a table 510 and a graph 520 to show information indicating that the individuals ID_505_K1, ID_505_K10, ID_505_K102, ID_505_K108, and ID_505_K109 are expected to have breeding values of −3.142, 33.511, 8.792, −10.242, and 32.504 for the oleic acid phenotype, and breeding values of −4.057, −34.516, −19.058, −6.416, and −35.324 for the erucic acid phenotype, respectively. (The breeding values may be calculated through a predetermined scaling process.)

Meanwhile, referring to FIG. 6, the service provision system 200 according to one embodiment of the invention may provide the user with a result of validating the at least one statistical model.

According to one embodiment of the invention, cross validation 611 using a K-fold method may be performed to validate performance and error occurrence of the statistical model for generating the estimated information, and graphs 620, 630, 640 showing a result of the validation may be provided to the user. Meanwhile, according to one embodiment of the invention, the validation may be performed for each target phenotype 610.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a prediction about breeding, comprising the steps of:
acquiring from a user at least one of information on at least one target phenotype to be had by a subject individual and information on limiting conditions related to the subject individual;
determining genotypes that satisfy the limiting conditions, among genotypes that are correlated with the at least one target phenotype; and
providing the user with at least one of estimated information on at least one phenotype acquirable by mating the determined genotypes and estimated information on a probability of the at least one target phenotype being acquired by mating the determined genotypes, on the basis of at least one statistical model.

2. The method of claim 1, wherein in the determining step, the genotypes that are correlated with the at least one target phenotype are determined on the basis of single nucleotide polymorphisms (SNPs) that affect the at least one target phenotype at or above a predetermined level.

3. The method of claim 1, wherein in the providing step, information on a breeding value of the at least one target phenotype is further provided.

4. The method of claim 1, further comprising the step of:
providing at least one recommended mating combination with reference to the estimated information.

5. The method of claim 1, further comprising the step of:
providing the user with a result of validating the at least one statistical model.

6. A non-transitory computer-readable recording medium having stored thereon a computer program for executing the method of claim 1.

7. A system for providing a prediction about breeding, comprising:
an information acquisition unit configured to acquire from a user at least one of information on at least one target phenotype to be had by a subject individual and information on limiting conditions related to the subject individual;
a genotype determination unit configured to determine genotypes that satisfy the limiting conditions, among genotypes that are correlated with the at least one target phenotype; and
a result provision unit configured to provide the user with at least one of estimated information on at least one phenotype acquirable by mating the determined genotypes and estimate information on a probability of the at least one target phenotype being acquired by mating the determined genotypes, on the basis of at least one statistical model.
